(19) United States
(12) Patent Application Publication
(10) Pub. No.: US 2004/0095661 A1
(43) Pub. Date: May 20, 2004

(54) Mirror with highly selective reflection band

(76) Inventors: Giuseppe Chidichimo, Rende (IT); Alexander Fedorovich Khokhlov, Nizhni Novgorod (RU); Galina Khokhlova, Nizhni Novgorod (RU); Alexander Ivanovich Mashin, Nizhni Novgorod (RU); Yarosiav Sergeyev, Rende (IT)

Correspondence Address: Striker Striker & Stenby, 103 East Neck Road, Huntington, NY, 11743, US

(21) Appl. No.: 10/416,635

(22) PCT Filed: Nov. 19, 2001
(86) PCT No.: PCT/IT01/00578

(30) Foreign Application Priority Data
Nov. 17, 2000 (IT) CZ2000A000007

(51) Int. Cl. G02B 5/08; G02B 7/182

(52) U.S. Cl. 359/883

(57) ABSTRACT

The invention concerns some type of reflecting mirror that can be utilized as rear-view mirrors for automobiles. Such a mirror is made up of: one layer of amorphous material, not pyrolytic, with refraction index greater than 3.4 and lower than 3.8; one or more layers of materials having refraction index comprised between 1.3 and 1.5. This multi-layer may contain also: one or more layers of materials with refraction index comprised between 2.9 and 2.4; one high reflection layer of metallic type; one absorbent layer. Proposed mirrors, for the optical characteristics and for the disposition of the components, however they have an integral reflection superior to that of the already known other anti-glaring mirrors, they present a glaring in night vision lower than that one of the already known mirrors, because they reduce selectively spectral range to which human eye is more sensible. Furthermore, said mirror presents a chromatic fidelity higher than the one of already known other mirrors in night vision as well in day vision.

### FIELD OF THE INVENTION

The invention consists of “multi-layer mirrors, particularly adapt to serve as rear-view mirrors for motor vehicles. The expression “multi-layer mirror” defines devices that are able to reflect visible light that can be generally composed: a) of a transparent base, b) of a series of dielectric layers (the multi-layer), c) of a highly reflective metal layer, d) eventual absorbent layers.

### PRIOR ART AND NATURE OF THE INNOVATION PRODUCED BY THE PATENT

In this context the traditional aluminum mirrors are the most simple that reflect the radiations of the visible light without altering the spectrum. The mirrors that contain in addition to the metal layer also a series of dielectric layers, and for this reason are called multi-layer, have the property of refecting light spectra that are modified in their chromatic components in order to assure minor glaring to driver by modern halogen headlights that run in the same direction. In other terms, the multi-layer mirrors have been introduced to eliminate from the fight spectrum the chromatic components that most disturb the driver's eye [1]. However there are severe rules for this point about the characteristics of the systems used because the elimination of the monochromatic components can bring distortions that modify the nature of the optical information as to lead the driver to committing identification errors regarding objects and their movements. For example, a rear-view mirror must have an integral reflection of the light spectrum superior to 0.4 and must have chromatic properties such as not to lead to identification errors. The multi-layer mirrors are characterised by a deposit upon a glassy base of several layers of metal material and dielectric material. The most external layer from the glassy base can be either a highly reflective metal surface (made generally by aluminum or chrome) or else by a semiconductor layer (generally germanium-based) this one also highly reflective. Between this highly reflective layer and the glassy surface, various layers of dielectric material are added (generally oxides, fluorides and sulphides) that have different refraction indexes and thickness. According to the physical optic laws [2] the reflection spectrum of a multi-layer mirror of the type described above, critically depends on the arrangement of the various dielectric layers added between the glassy base and the reflective surface, on their thickness and on their refraction index.

Hereunder we describe a series of mirrors with intermediate multi-dielectric layers (between the glassy surface and the external metal surface) previously well known, before the present invention.

For example, a mirror [3] in which an intermediate multi-layer is used made up of three layers having the following characteristics is well known. The first layer (A1) is made of a material that has a high refraction index whose optical thickness is equal to λ₀/4 (being λ₀ the wave length of the light chosen for the control of the coating making). The second layer with a poor refraction index (B) has a thickness that is also equal to λ₀/4. The third layer (2A₂) whose thickness is λ₀/2 has once more a high refraction index. The formula of the intermediate multi-layer coating is in this case A₁B2A_{2.} The patent itself has a further solution according to which the intermediate multi-layer is made up of four layers A₁B₁A₂B₂ each of which has a λ/4 thickness. This type of multi-layer mirror has a high reflection coefficient in the spectral interval between 430 and 550 nm, while it has a poor reflection between 550 and 700 nm. It therefore shows a light blue colouring. A considerable drawback of this mirror is the considerable alteration of the chromatic balance of the objects. For example, red-coloured objects are not very visible in reflected light. A second serious drawback presented by such a mirror is given by the fact that the maximum light it reflects corresponds precisely to the band, centred around a λ=510 nm wave length, to which the eye has the maximum night sensibility [4]. The driver, of a vehicle with this mirror, is heavily glared by the tailing vehicle headlights, even if the mirror cuts a considerable visibility in the red chromatic band.

Other mirrors with reflecting multi-layers, recently invented, are reported in the reference [5]. These mirrors, for the nature, disposition and thickness of the layers used, present the drawback that they do not selectively reduce the reflection of the spectrum green band, and in some cases strongly cut the red band. While on one hand there is no decrease in the spectral component for which there is maximum sensibility during night vision, on the other hand the brightness is diminished and object chromaticity is distorted (the red coloured objects become less visible)

Other known multi-layer mirrors [6,7] are surely valid as far as the reflected light quality, inasmuch the minimum of this light falls within the wave length band between 480 and 550 nm. In this case however, the multi-layer dielectric between the glassy surface and the external metal surface is made up of several layers that are different one from another not only for the material used but also for the deposit methodologies used. This makes these mirrors not very suitable for industrial production and therefore expensive. Another drawback that can be attributed to them is the poor global brightness that makes them not very adapt for night driving.

The mirror described in reference [8] has a dielectric multi-layer whose number of layers (from 3 to 6) is inferior as to those presented in the mirrors claimed in references [6] and [7]. In this case, the invention can be industrialised at a lower cost but the drawback of a relatively poor night brightness of the mirror remains.

The patent [9] also describes a mirror in which the optical parameters are analogous to those of the mirror described in reference [8], even if less protected from a mechanical point of view.

A multi-layer mirror, upon which is depressed the spectral component reflection centred around 550 nm, is that reported in reference [10]. This mirror, here described in detail, will be used as a term of comparison to illustrate the superior quality of the mirrors subject of this invention. It contains, between the glass base and a metal layer or an external high reflection semiconductor, a multi-layer dielectric made up of at least one high refraction index layer λo/2 thick (deposited on the glassy base) and at least one low refraction index layer that has an optical thickness between 0.05 and 0.4 times λo. In this invention, the dielectric layer with a high refraction index (1.9-2.4) is made up of at least one of the following compounds: SiO₂, TiO₂, Ta₂O₅, ZrO₂, HfO_{2,} ZnS. The dielectric layer with a low refraction index (1.3-1.8) is instead made up of at least one of the following compounds: SiO₂, Al₂O₃, MgF₂, CeF₃. Alternatively, the high refraction index layer can be made up of Al₂O₃ and/or CeF₃, when the material for the lower refraction index layer are properly chosen. The external reflective layer made with metals and semiconductors such as: Cr, M, Al, Ag, Co, Fe, Si and Ge, or else with alloys containing at least one of these components.

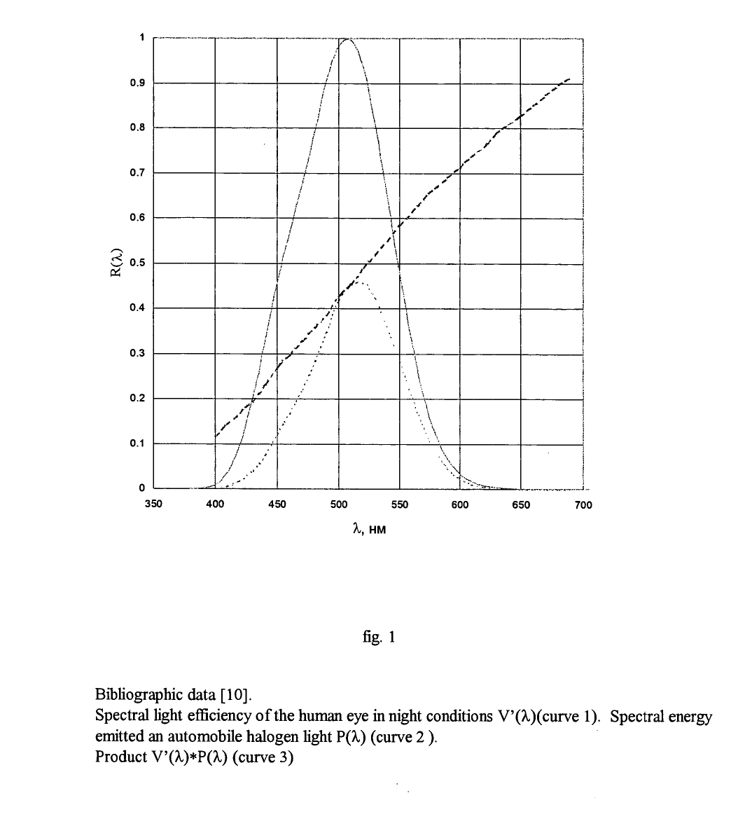

FIG. 1 shows the spectral light efficiency of the human eye in night conditions V′(λ)(curve 1). The same figure indicates curve 2 that represents the spectral energy emitted by an automobile halogen fight P(λ), while curve 3 is instead the product V′(λ)P(λ) and hence illustrates the sensibility spectrum that the human eye manages to have at night with respect to the brightness of a an automobile halogen lamp. FIG. 1 shows clearly that the greatest human eye sensiblity” during night vision falls into 510 and 530 nm frequency range. Therefore the greatest night glaring power is given precisely by this luminous band. Staring from this consideration, the patent reference authors [10] have proposed, to correct the halogen headlight glaring through rear-view mirrors that have a minimum reflection minima in the 510-530 nm frequency band.

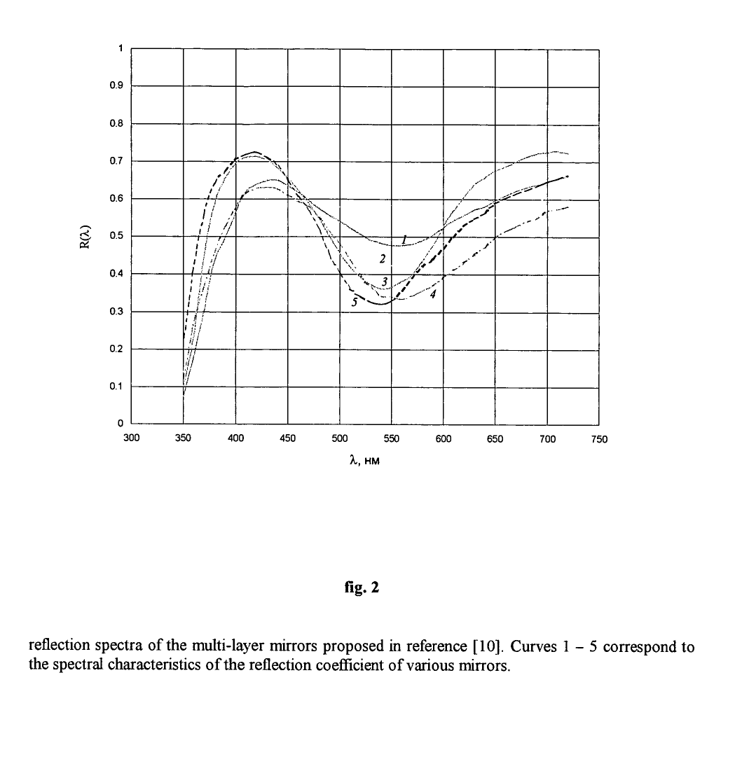

FIG. 2 reports the reflection spectra of the multi-layer mirrors proposed in reference [10]. Curves 1-5 (FIG. 2) correspond to the spectral characteristics of the reflection coefficient of various mirrors, according to the following outline:

| | |
|---|---|
| curve 1 - S 2A₁ B₁ M₁ | λ₀ = 540 nm, |
| curve 2 - S 2A₁ 1/2B₁ M₁ | λ₀ = 600 nm, |
| curve 3 - S B₂ 2A₁ B₁ M₂ | λ₀ = 540 nm, |
| curve 4 - S A₁ A₂ B₂ M₁ | λ₀ = 540 nm, |
| curve 5 - S B₂ A₁ A₂ 1/2B₁ M₁ | λ₀ = 600 nm, |

where S is the base;
A is the high refraction dielectric material;
B is the low refraction dielectric material;
M is the high reflection metal or semiconductor layer;

In particular:

| | |
|---|---|
| A₁ - TiO_{2;} | A₂ - ZrO₂; |
| B₁ - MgF_{2;} | M₁ - Cr; |
| B₂ - SiO_{2;} | M₂ - Ge; |

The optical thickness of the coating layers is such that the layers A and B correspond to λ₀/4; 2A corresponds to λ₀/2; ½B corresponds to λ₀/8.

FIG. 2 curves do not show that the rear-view mirror of the reference [10] effectively eliminates glaring. In particular the maximum effectiveness is reached with the mirror in which the dielectric is made up of four layers (curve 5, FIG. 2). It is however necessary to underline the fact that the mirror at issue does not assure the driver the maximum brightness that can be reached with the technologies used. In the case of the mirror subject of the present invention, the brightness has been optimised instead. According to references [1,4,13] the relative brightness V(λ.) perceived at night by the driver when looking through a rear-view mirror is given by the following equation:

V(λ)=V(λ)·R(λ)·P(λ),

where

V′(λ) is the average relative brightness of the human eye at night in an optical system [symbol] monochromatic source—human eye [symbol] [4];

P(λ) is the spectral power of the automobile halogen headlight;

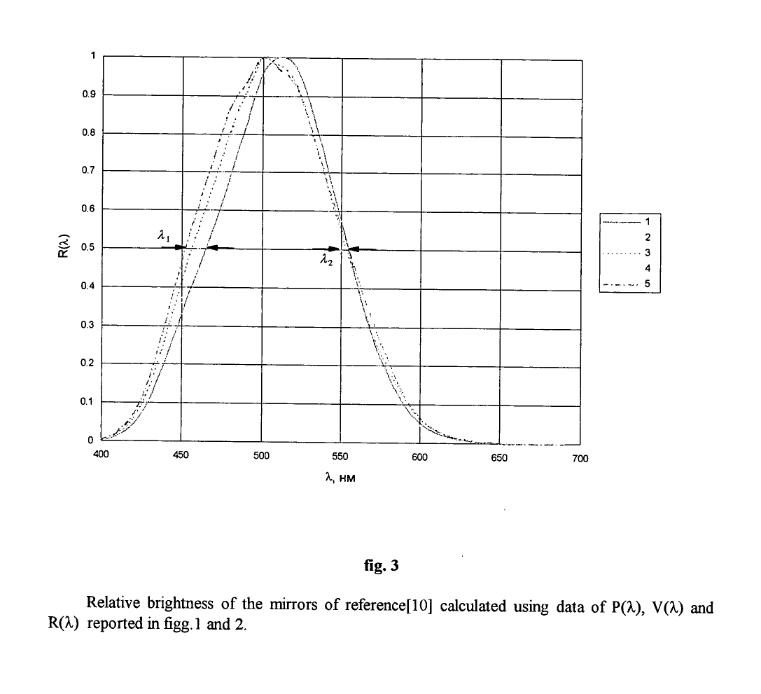

R(λ) is the reflection coefficient of the multi-layer rear-view mirror. Using P(λ), V(λ) and R(λ) data of reference [10] reported in FIGS. 1 and 2 it is simple to obtain the relative brightness of the mirrors. The results of this V(λ) calculation procedure are reported in FIG. 3.

Amongst the main parameters that characterise the spectra (the optical one included) there are the spectrum width at half height, and their shape.

These parameters are extremely important in reference to the capacity of not distorting beyond certain limits the chromatic characteristics of the objects (see for Example FIG. 3, in which λ₁ (blue limit) and λ₂ (red limit) are defined that define Δλ=λ₂−λ spectral width. For the five multi-layer mirrors, 1-5 reported in reference [10] that AX proves to be equal respectively to 84, 87, 95, 90 and 100 nm. We believe that this parameter is very important for the night driver's comfort. In fact, the greater AX is the more the driver manages to perceive the colours of the objects without chromatic distortions that can alter his understanding of the nature of the objects themselves.

The aim of the invention was the making of a multi-layer rear-view mirror for vehicles that couples

a) A stronger anti-glaring effect, as to known mirrors, through an effective reduction of the chromatic components between 510 and 530 nm;

b) A greater relative brightness for the driver, as to known multi-layer mirrors;

c) a chromatic distortion inferior to that of other known mirrors (AS greater);

d) a greater construction ease, to guarantee production cost abatement and a simple adaptability, this aim is pursued by the use of new materials and by the reduction to the minimum of the number of the layers composing the multi-dielectric layer inserted between the base and the external metal layer.

In other words the invention here presented, even if it does refer to concepts that are recognised in the rear-view mirror technology field, concerns the use of materials not yet used in this context and their ideal arrangement, to obtain rear-view mirrors that even having high brightness, selectively lower the luminous component that glares the human eye during night vision without eliminating chromatic components essential to maintain the chromaticity the most natural possible of the objects. We will demonstrate with quantitative data that the new technical solution here presented satisfies these requirements to a greater extent as to other similar findings made with alternative material and dispositions. In addition to the aspects that regard the quality of the mirror we produce, the invention also refers to fabrication ease. From this point of view, it must also be considered that the most complex passage from the industrial fabrication point of view of the multi-layer mirrors is precisely the deposition of the various dielectric and metallic layers. The multi-layer coating is made with different physical-chemical methods for example vacuum evaporation, the plasma or magnetron ion spraying, the plasmochimica hydride and metallo-organic compound deposition. One of the problems that in the past has complicated the industrialisation of anti-glaring mirrors has been the necessity to have to use different processes for the deposition of the highly reflective metallic layers and for the deposition of the dielectric different refraction index layers. For the nature of the material used in the mirrors that represent the object of this invention, the high reflection metallic film is deposited with the same method used for the deposition of the dielectric multi-layer coating, within the same process cycle. This assures a considerable simplification of the fabrication process.

In our case, the intermediate multi-dielectric layer contains at least one layer of high refraction index semi-conductor material and at least one layer of dielectric material with a low refraction index. The high refraction index layer, in the 3.4-3.8, range can be made up of a) amorphous silicon (α-Si); b) hydrogenated amorphous silicon (α-Si:H), c) an amorphous silicon and germanium alloy (α-SiGe), d) an amorphous hydrogenated silicon and germanium alloy (α-SiGe:H). The layer of low refraction index dielectric material, in the 1.3-2.3, range is preferably made up of oxides like SiO₂, Al₂O₃, or else of fluorides like MgF₂, CeF₃ or also from their mixtures or other dielectric material with the refraction index in the indicated range.

The high reflection metallic layer formed on the multi-layer coating has preferably a reflection coefficient equal to 0.6 or greater than 0.6, in the range of the visible. It can be made up of a single metal such as Cr, Ni, Al, Ag or other similar, or else by a metallic alloy whose reflection coefficient is analogous to those above indicated.

It must be stressed that an innovative element introduced by the present patent is made up of the use of amorphous material such as α-Si, α-Si:H, α-SiGe, α-SiGe:H, in at least one of the layers of the reflective multi-layer. This amorphous semi-conductor material presents at least three advantages with respect to the other non-amorphous material:

they are depositabile at low temperatures,

they are perfectly transparent,

their refraction index can be varied.

In this patent we will present the following three different formulas of mirrors:

1. Formula SA2BM mirrors, in which:

S is the glass or other transparent material base;

A is a high refraction (in the range 3.4-3.8) semi-conductor layer;

B is a dielectric material layer with a low refraction (refraction index 1.3-2.3) whose optical thickness is equal to We/2;

M is a high reflection metallic layer.

2. Formula S1/2A₁½A₂2BM mirrors, or else S¼A₁¾A₂2B M,

in which:

1/2A₁, ¼A, are high refraction index dielectric layers, within the 3.4-4.8 range whose optical thickness is λ₀/8 and λ₀/16;

½A₂, ¾A₂ are high refraction index dielectric layers whose optical thickness is λ₀/8 and 3λ₀/16, that are made with material whose refraction index is higher as those with which layer B is made.

B is a dielectric material layer with a low refraction (refraction index 1.3-2.3) whose optical thickness is equal to 2/2;

M is a high reflection metallic layer.

3. Mirrors in which the reflective metallic layer is eliminated and in which the reflecting task is generated by the interference effect of layers of semi-conductors separated by dielectric layers.

As can be seen, by observing the reflection spectra of the mirrors described in the examples here reported, said mirrors, even having an analogous integrated reflection coefficient, and in many cases superior, in comparison to known mirrors, reduce glaring more than three times, during night vision, as compared to aluminum mirrors. While the best known mirrors reduce glaring, as compared to aluminum mirrors, of a factor inferior to two. Furthermore, while the best known anti-glaring mirrors are blue mirrors [14], the mirrors here presented reflect both blue and red. They have a reflection coefficient that as compared to the imposed standard (above 35%) for all spectral regions, but reduces up to 20% of the reflectiveness only in spectral zones where human eye sensibility is greatest. According to international standards (see in particular [11,12]), the integral reflection coefficient of the rear-view mirrors must not be inferior to 0.38-0.40. Our mirrors in all cases have an integral reflection coefficient in the visual range above 0.47.

Ultimately, our mirrors have an effective reflection coefficient considerably higher as compared to that of other mirrors. When they are used as rear-view mirrors in automobiles, furnish more complete and chromatically precise information of the vehicles to the rear, as to that given by blue mirrors. Furthermore, they present the advantage of better visual contrast and hence increase safety above all in crepuscular hours and on overcast days.

### EXAMPLE 1

A first example of the invention is made up of multi-layer rear-view mirror for vehicles, containing a transparent base, a multi-layer dielectric film deposited upon the transparent base and a high reflection metallic layer deposited upon the multi-layer dielectric film. The intermediate multi-layer dielectric film, between the base and the metallic layer, includes a layer of material with a high refraction index and a layer of material with a low refraction index.

The base that is used in the technical solution presented is transparent. It must be for the most part flat on both sides, but can be also convex or concave, in accordance with the technical regulations in force [13].

The optical thickness of the high refraction index semi-conductor layer is equal to λ₀/4 (where λ₀ is the wave length used for the control in the fabrication of the coating) and the optical thickness of the layer with a low refraction index is λ₀/2. The optical thickness of the high refraction index semi-conductor layer must not exceed the value of λ₀/4 also to exclude the light absorption effect on the layer, that may reduce the brightness of the mirror. Therefore the multi-layer mirror dealt with in this Example has a multi-layer coating with two layers and its formula is:

SA2BM,

where S is the glass base;

A is the high refraction index semi-conductor layer in the 3.4-3.8 range;

2B is the layer of low refraction dielectric material (1.3-2.3 refraction index) whose optical thickness is equal to λ₀/2; M is the high reflection metallic layer.

The disposition of the low and high refraction layers of the intermediate multi-layer dielectric coating can not be varied and must necessarily respect the following order. The high refraction coefficient semi-conductor layer must be deposited on the surface of the transparent base. On the high refraction index layer is deposited the low refraction index layer. On the layer with a low refraction index is deposited the high reflection metallic layer. The disposition of the layers indicated is important for the making of spectral characteristics distinguished by good brightness and low glaring.

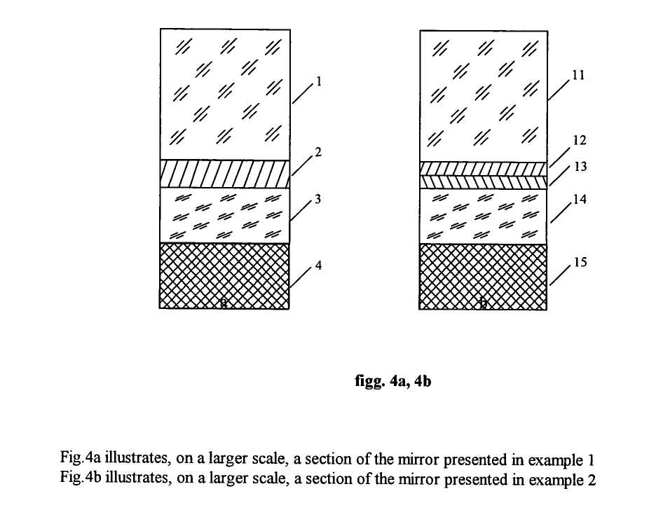

FIG. 4a presents on a larger scale the section of the mirror in which the multi-dielectric layer contains two layers. The figure highlights:

1. is the glass base;

2. is a semi-conductor layer (A) in amorphous silicon (α-Si), whose refraction index 3.5; optical thickness is λ₀/4 (in this Example λ₀ is the wave length of control for the fabrication of the coating: equal to 520 nm and therefore λ₀/4 is equal to 130 nm),

3. is a layer of material in SiO₂ with a low refraction index (n=1.46) (2B) optical thickness λ₀/2 (260 nm);

4. is a metallic film in A1.

The layer A can be made also of, α-SiH, α-SiGe, α-SiGeH

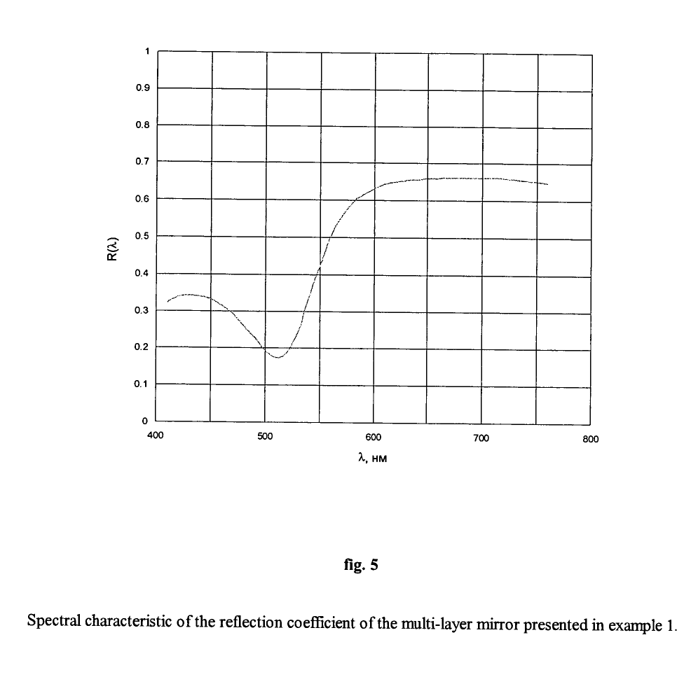

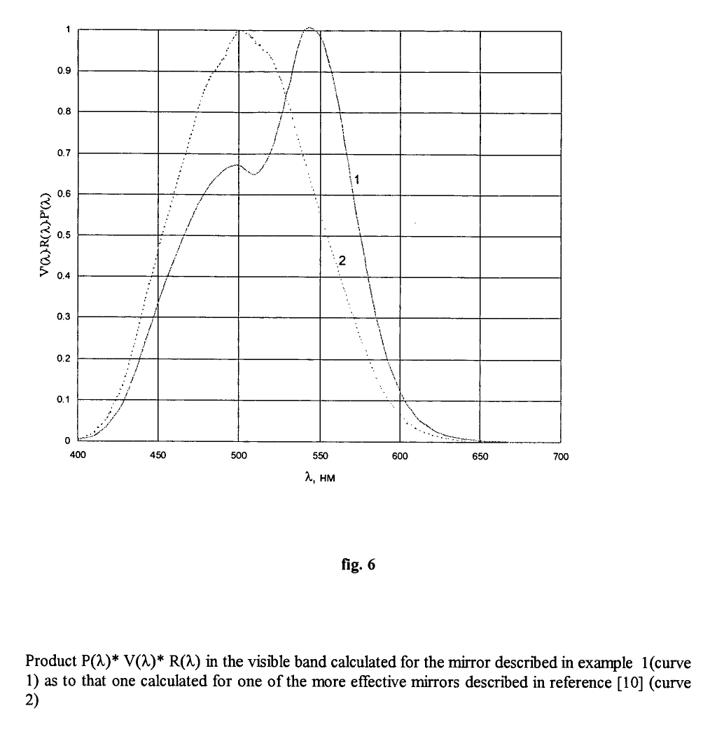

The spectral characteristic of the reflection coefficient of the multi-layer mirror given is reported in FIG. 5. Observing FIG. 5 one can see well that the mirror eliminates efficiently glaring having a low reflection coefficient in the wave length range between 480 and 530 nm in which the product of the human eye sensibility during night vision for the spectral power of a halogen automobile light reaches the greatest values. It can also be seen that the mirror has a high reflection coefficient in the blue zone (430-480 nm) and in the red zone (540-700 nm) of the spectrum where human eye sensibility to brightness is low The reflection selectivity of the mirror does not lower the integral value of the reflection in the visible band that proves equal to 0.51. FIG. 6 compares the product P(λ)*V(λ)*R(λ) in the visible band calculated for the mirror described in this example (curve 1) as to that calculated for one of the more effective mirrors described in reference [10] (curve 2). From FIG. 6 it can be inferred that for the mirror described in the example the semi-width of the relative sensibility Δλ is equal to 110 nm and is 10 nm larger as compared to that of the mirror described in reference [10] that besides has a greater number of dielectric layers in the dielectric multi-layer (four). Ultimately, the mirror described in Example is characterised by the fact of having a greater anti-glaring capacity, a greater fabrication simplicity, a minor chromatic distortion, a greater luminosity as to other analogous known mirrors.

### EXAMPLE 2

This example reports a multi-layer mirror in which the intermediate dielectric layer between the surface of the base and the high reflection metallic layer, is made up of three layers.

The formula of the mirror is hence:

S½A₁½A₂2BM or S¼A₁¾A₂2BM,

Where 1/2A₁, 1/4A₁ are layers with the refraction index between 3.4 and 3.8, optical thickness equal to λ₀/8 and λ₀/16, while

1/2A₂, ¾A₂ are dielectric layers, optical thickness λ₀/8 and 3λ₀/16, made with, material having a higher refraction index as compared to those with which layer B is made. If layer B is made in SiO₂ (n=1.46) or MgF₂ (n=1.38) with optical thickness S42 then for layer A₂ TiO₂ (n=2.30), ZrO₂ (n=2.02), HfO₂ (n=1.98) et al are used. B is a dielectric material layer with a low refraction (refraction index 1.3-2.3) whose optical thickness is equal to λ₀/2; M is a high reflection metallic layer.

FIG. 4b illustrates, on a larger scale, a section of the multi-layer mirror presented in this example. 11 is the glass base. 12 is the semi-conductor layer (1/2A₁) optical thickness λ₀/8 (in this Example λ₀ is equal to 520 nm and therefore λ₀/8 is equal to 65 nm), made up of amorphous silicon (α-Si), whose refraction index is 3.5. 13 is the layer of material dielectric with a high refraction index (½A₂) optical thickness λ₀/8 (65 nm), made up of ZrO₂ (n=2.02). 14 is the layer of dielectric material with a low refraction index (2B), optical thickness λ₀/2 (260 nm), made up of SiO₂ (n=1.46). 15 is the film in A1. The layer A₁ can be made up also of α-SiH, α-SiGe, α-SiGeH

The deposition of the high and low refraction layers is defined. The semi-conductor layer (A₁) is deposited on the surface of the base; On the layer (A1) is deposited the high refraction dielectric layer (A₂) upon which is deposited the low refraction dielectric layer (3) that in turn is covered by the high reflection metallic layer (M). This deposition of the layers must be respected if one wishes to give spectral characteristics, to the reflection coefficient of the mirror, such as to guarantee high brightness and high anti-glaring power.

Choosing the optimal optical thickness of the high refraction semi-conductor layer (not more than λ₀/4) the light absorption in the semi-conductor layer proves minimal and does not negatively influence the reflective layer quality. On the other hand, the great difference (due to the use of semi-conductor material) between the values of the refraction indexes of the alternating layers of the multi-layer coating allowing to obtain amore effective anti-glaring effect as compared to that given by known mirrors containing 2 or 3 layers in the intermediate dielectric layers. This solution furthermore allows to enlarge the 10-30 nm Δλ parameter, that is to improve the relative brightness, and to eliminate chromatic distortions.

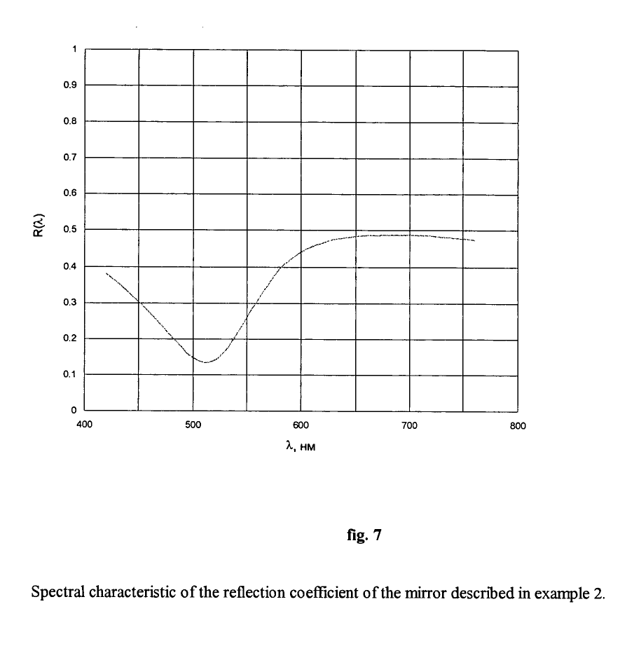

The spectral characteristic of the reflection coefficient of the mirror described is reported in FIG. 7 in which it can be ascertained that the mirror has a high reflection coefficient both in the blue zone (430-480 nm), and in the red zone (540-700 nm) of the spectrum where the human eye sensibility irradiation is low. The reflection selectivity of the mirror does not lower the integral value (of the visible band) of the reflection coefficient, which is equal to 0.38.

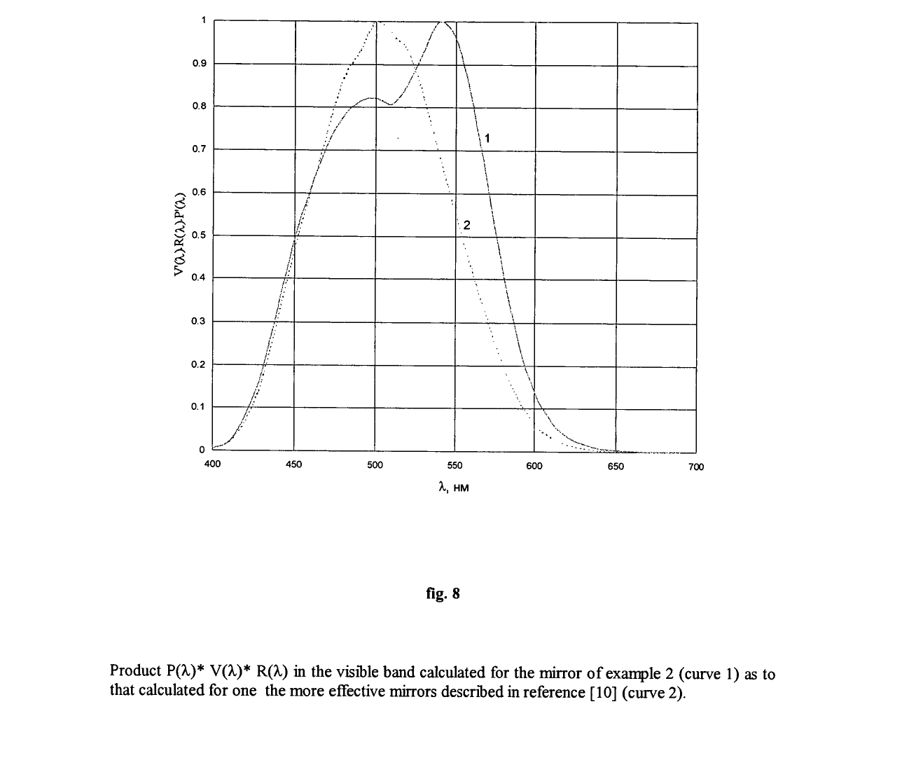

FIG. 8 reports the product P(λ)*V(λ)*R(λ) in the visible band calculated for the mirror of this example (curve 1) as to that calculated for one of the more effective mirrors of the reference [10] (curve 2). From FIG. 8 it can be inferred that for the mirror of this example the semi-width of the relative sensibility Δλ is equal to 128 nm, and turns out to be 30 nm larger than the mirror with 4 dielectric layers presented in reference [10].

### EXAMPLE 3

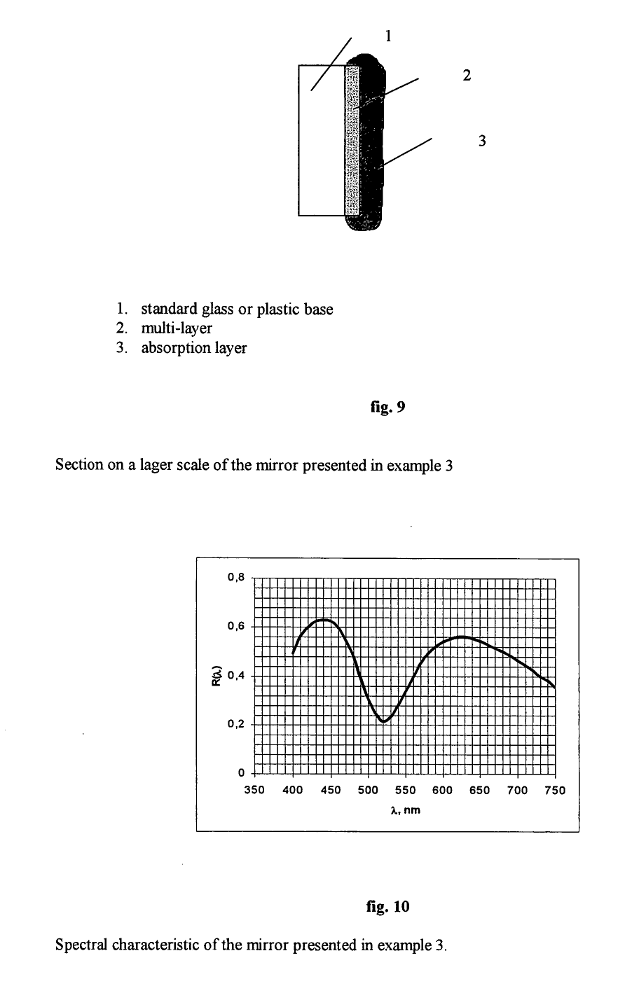

The mirror presented in this example is illustrated in FIG. 9. It is made up of a standard glass base 1, of a multi-layer dielectric/semi-conductor with more than one layer 2, and by a protective absorption layer 3. In this mirror, the layer of metal does not exist that in precedent examples was necessary to obtain a sufficiently high reflection. In this case, the high reflection coefficient in the spectral range is reached through the interferential reflection at the level of the dielectric/semiconductor multi-layer. The surface with more than one layer is made up of a sequence of alternate layers of semi-conductors and dielectrics of different thickness s. As the layer with the greatest refraction coefficient (n>3.5), the amorphous cremnio is used. All layers of this surface have been deposited through electronic vacuum evaporation.

The formula of the mirror is:

SA₁B₁2A₁B₁A₂C,

where S—transparent base;

A₁—ZrO₂ with the optical thickness equal to λ₀/4;

A₂—α-Si with the optical thickness equal to λ₀/4;

B₁—SiO₂ with the optical thickness equal to λ₀/4;

C—absorbent layer.

The layer A₂ can be made also by α-SiH, α-SiGe, α-SiGeH

To obtain such a surface as support wave the wave λ₀=510 nm was used.

The protective absorption layer 3 must absorb the light in the entire visible range. Such a layer can be made in black epoxy spray paint or else in lacquer, depositable upon the back of the mirror through spraying, curtain-coating or roller-coating methods.

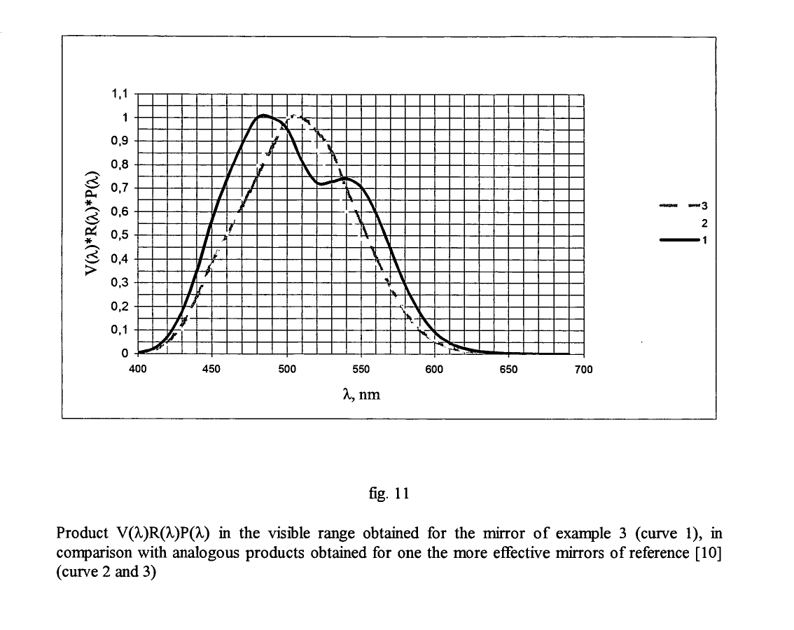

The spectral characteristic of the reflection coefficient of the mirror is reported in FIG. 10. The integral reflection coefficient exceeds 47% (according to the existing rules it must not be inferior to 338/o). By analogy with examples 1 and 2, FIG. 11 reports the product V(λ)R(λ)P(λ) in the visible range obtained for the mirror of this example (curve 1), in comparison with analogous products obtained for the mirrors of reference [10] (curve 2 and 3) it should be noticed that for the mirror claimed in this patent the spectral visibility width 20 nm greater, this demonstrates the greater colour transmission fidelity.

### BIBLIOGRAPHY

1. Geda N. F. Misurazione parametri degli strumenti optoelettronici.—M.: Radio i sviaz, 1981.-386p. (in russo).

2. Rosenberg G. V. Ottica dei rivestimenti a strati sotfili.—M.: Fizmatgiz, 1958.-570 p. Cm russo).

3. Brevetto Giappone N 212704/1985.

4. Vocabolario internazionale dell'ingogneria della luce.—M.: Fizmatgiz, 1963.-428 p. (in russo)

5. Brevetto USA N 6065840, G2B 5/08, 2000

6. Brevetto Giappone N 74005/1988.

7. Brevetto USA N 4805989, G02B 5/08, 1989.

8. Brevetto USA N 4921331, G02B 5/08, 1990.

9. Brevetto USA N 5007710A, G02B 5/08, 1991.

10. Brevetto USA N 4955705, G02B 5/08, 1990.

11. E/ECE/324 (E/CE/EC S/505) Rev.1/Add.45/Rev.1 Regulation No. 46

12. Japanese Industrial Standard (JIS) D 5705 “Automotive Mirror System”

13. Vocabolario fisico enciclopedico.—M.: Sov. Enciclopedia, 19950.928 p. (in russo).

14. Brevetto USA N 5745291, G02B 5/08, 1998

1. Mirrors with highly selective reflection band suitable to serve as rear-view mirrors for automobiles made up of
a transparent glass base or in plastic material,
a multi-layer deposited upon the transparent base that contains:
One layer with refraction index not inferior to 3.4.
One or more layers of material having a refraction index between 1.3 and 1.5
A third layer
Characterised by the fact that the layer with the higher refraction index is made up of amorphous material, not pyrolytic, and that the layer or the layers with refraction index between 1.3 and 1.5 are λ/2 wide.

2. Mirrors with highly selective reflection band suitable to serve as rear-view mirrors for automobiles of the type claimed in claim 1, in which the multi-layer is composed by the following layers:
1—a λ/4 □ thick semi-conductor layer, chosen between: a) amorphous silicon (α-Si); b) hydrogenated amorphous silicon (α-Si:H); c) an amorphous alloy of silicon and germanium (α-SiGe), d) a hydrogenated amorphous alloy of silicon and germanium (α-SiGe:H);
2—a λ/2 thick layer of dielectric material, with a lower refraction index, in the 1.3-1.5 range, made up of oxides such as SiO₂, Al₂O₃, or of fluorides such as MgF₂, CeF₃ or also of their mixtures with the refraction index in the indicated range.
3—a high reflective metallic layer.
The layers 1, 2, 3 are deposited in progressive order upon the base.

3. Mirrors with highly selective reflection band suitable to serve as rear-view mirrors for automobiles of the type claimed in claim 1, in which the multi-layer is composed by the following layers:
1—a λ/8 or λ/16 thick semi-conductor layer, chosen between: a) amorphous silicon (α-Si); b) hydrogenated amorphous silicon (α-Si:H); c) an amorphous alloy of silicon and germanium (α-SiGe), d) a hydrogenated amorphous alloy of silicon and germanium (α-SiGe:H);
2—an intermediate refraction index layer, λ/8 or λ 3/16 thick made preferably by TiO₂(n=2.30) or by ZrO₂ (n=2.02) or by HfO₂ (n=1.98) or by other dielectrics with analogous refraction indexes;
3—a layer with a low refraction index, λ/2 thick, preferably made up of SiO₂ (n=1.46) or MgF₂ (n=1.38) or by other dielectrics with analogous refraction indexes.
4—a reflective metallic layer.
Layers 1, 2, 3, 4 are deposited in progressive order upon the glassy base.

4. Mirrors with highly selective reflection band suitable to serve as rear-view mirrors for automobiles of the type claimed in claim 1, in which the multi-layer is composed by the following layers:
two layers (A₂) of material with an intermediate refraction index (1.9-2.4) such as TiO₂(n=2.30) or ZrO₂ (n=2.02) or HfO₂ (n=1.98) or by other dielectrics with analogous refraction indexes;
two layers (B) of material with a low refraction index (1.3-1.5) like SiO₂ (n=1.46) or MgF₂ (n=1.38) or other dielectrics with analogous refraction indexes.
a layer (A₁) of material with a high refraction index (3.4-3.8), chosen between: a) amorphous silicon (α-Si); b) hydrogenated amorphous silicon (α-Si:H); c) bi-coordinated amorphous silicon, d) an amorphous alloy of silicon and germanium (α-SiGe), e) a hydrogenated amorphous alloy of silicon and germanium (α-SiGe:H);
a layer (C) optically absorbent made up of a black epoxy resina or other analogous material.
The layers are deposited upon the base in order A₂B2A₂BA₁C. A_{1,} A_{2,} B correspond to a thickness equal to λ/4.

5. A fabrication process for the mirrors of claims 1-4, in which all dielectric, semi-conductor and metallic layers are deposited upon the base in one processing step, that is with a single deposition procedure in which the material that form the various layers is progressively changed.

6. A process of the type claimed in claim 5 in which the temperature of the process remains inferior to 100° C.
